(19) United States
(12) Patent Application Publication
(10) Pub. No.: US 2003/0191721 A1
(43) Pub. Date: Oct. 9, 2003

(54) System and method of associating communication devices to secure a commercial transaction over a network

(75) Inventor: Marc Fiammante, St Laurent du Var (FR)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 09/794,305

(22) Filed: Feb. 27, 2001

(30) Foreign Application Priority Data
Feb. 29, 2000 (EP) 00480024.9

(51) Int. Cl. G06F 17/60

(52) U.S. Cl. 705/65

(57) ABSTRACT

A system and a method for associating communication devices like a computing device and a wireless portable device so as to carry out secure transactions over an untrusted network like the Internet are disclosed. The communication devices are assumed to be independently capable of communicating with an electronic commerce site managing a directory of legitimate users which all possess a token like a smart-card. Whenever a user desires to carry out a secure transaction, the user initially prepares the transaction from a first communication device like a personal computer. When completed with the preparation, a signature of the user is obtained from a second communication device like a mobile phone through which the legitimate user is reachable and which is enabled with the token of the user. When contacted from the electronic commerce site, the second communication device is used to check, validate, sign and transmit the signed secure transaction to the electronic commerce site where final processing of the commercial transaction can be completed.

### BACKGROUND OF THE INVENTION

1. Field of the Invention

The present invention relates generally to the electronic commerce and more particularly applies to commercial-like transactions taking place over a network like the Internet that requires confidentiality, authentication, integrity, and non-repudiation.

2. Description of the Related Art

Commerce over the Internet is dramatically expanding. It involves all sorts of transactions implying the movement of electronic money. All of this is taking place over what is, basically, a very unsecured network. Therefore, based on cryptography, numerous techniques and methods have been devised not only ensuring confidentiality of the transactions but also, this is often even more important, authentication, integrity and non-repudiation. Authentication is required to ascertain the origin of a transaction so as no one should be able to masquerade as someone else. Integrity is key to make sure that a transaction has not been modified, unintentionally or maliciously, on its way through the network to a destination, e.g., a server aimed at processing the customer orders. Finally, non-repudiation is essential to make sure that a completed transaction, that may involve a lot of money, may not just be denied later on by any of the participants.

Accessing the Internet is mainly achieved nowadays from a personal computer (PC), a workstation (WS) or any other similar computer device capable of running a piece of browser software in order to be able to get on the World-Wide Web (Web). The Web is a ubiquitous application that has accompanied the explosive growth of the Internet in past years. Thus, an Internet commerce site is a particular Web site aimed at handling commercial transactions. A well-known site is located at http://www.amazon.com/. It is a huge virtual bookstore selling also music and videos. The site claims that millions of people from many countries have indeed made online shopping on the site. Although such sites also claim they are completely safe, such sites actually fail to satisfactorily meet confidentiality, authentication, integrity and non-repudiation. To attempt to reach these objectives, a computer device would need to be equipped with a smart card reader and a user would have to carry a token, e.g., an intelligent chip-card or a smart-card, so that authentication based on the knowledge (personal identification number or password) and possession (token) principle can be carried out. Smart-cards are also suitable for securely storing certificates and encryption keys. Smart cards with an integrated crypto-processor can implement cryptographic functions directly on the card so that the keys never leave the smart card. For example, a smart card may implement an encrypted digital signature with a user private key appended to it. A recipient may therefore check the transaction with a user public key and make sure that the transaction has not been altered on its way and has originated by the person possessing the corresponding user private key. This eliminates any possibility of the key falling into the wrong hands.

However, all of this is only possible if the computer device is indeed equipped with the proper hardware, e.g., a card reader and the corresponding software or device driver to perform the adaptation with the operating system (OS) running on the computer device. This is a new technology and a new type of I/O port to be added to the computer device. This has a cost which does not fit well with the general trend that wants to reduce as much as possible the operational expenses of a private or enterprise network to thereby lower the cost of terminal equipment and total cost of ownership. Thus, in practice, computer devices are still seldom equipped with such card readers. Although a separate chip card reader can always be later added to a particular computer device, separate chip card readers require the installation of corresponding software and device driver(s).

Another even more explosive market is the one of mobile wireless communications. This market was initially driven by mobile digital cellular phones, but is rapidly evolving to cover other applications in relation with the Internet such as e-mail. It is anticipated that electronic commerce applications such as personal banking, stock trading, gambling, ticket reservations and shopping will soon become commonly available on mobile phones. Hence, the security of data communications over wireless networks has become a major concern to mobile commerce businesses and users. This concern has triggered the development of products to build secure systems that solve the core requirements of confidentiality, authentication, integrity and non-repudiation for electronic commerce security. Also, standards are being put in place to control the development of such products and make sure that they may inter operate. The Wireless Application Protocol (WAP) Forum (http://www.wapforum.org) has thus become the de facto worldwide standard for providing Internet communications and advanced telephony services on digital mobile phones, pagers, personal digital assistants and other wireless terminals. Therefore, all these mobile devices, contrary to computer devices, are promised to be up-front equipped with all necessary features and functions so as to guarantee security of electronic commerce transactions. Nevertheless, mobile phones all have inherent limited display capability and a rudimentary user interface along with limited processing power, battery life and storage capabilities.

It is desirable therefore to provide a method and a system that combine the display and user interface capabilities of a computer device and the built-in security features of wireless mobile devices to facilitate convenient and secure electronic commerce transactions.

### SUMMARY OF THE INVENTION

A first form of the present invention is a method for associating a commerce site, a first communication device, and a second communication device in executing a commercial transaction over a network. The first communication device and the commerce site are operated to prepare and approve the commercial transaction. The commerce site is operated to provide a signature request to the second communication device upon approval of the commercial transaction. The second communication device is operated to provide a signature to the commerce site in response to the signature request.

A second form of the present invention is a method for associating a first communication device and a commerce site after a preparation and an approval of a commercial transaction by a second communication device and the commerce site. The commerce site is operated to retrieve an identification record corresponding to a user of the first communication device and the second communication device. The commerce site is operated to establish a communication link between the first communication device and the commerce site in response to the identification record. The commerce site is operated to provide a signature request to the first communication device upon an establishment of the communication link.

A third form of the present invention is a method for completing a commercial transaction prepared and approved by a first communication device and a commerce site. A second communication device is operated to examine a signature request from the commerce site. The second communication device is operated to identify a user of the first communication device. The second communication device is operated to provide a signature for the commercial transaction in response to an identification of the user.

A fourth form of the present invention is a system for executing a commercial transaction. The system comprises a first communication device, a second communication device, and a server running a commerce site. The first communication device and the server are operable to prepare and approve the commercial transaction. The server is further operable to provide a signature request to the second communication device upon an approval of the commercial transaction. The second communication device is operable to provide a signature to the server in response to the signature request.

A fifth form of the present invention is a computer program product in a computer usable medium for associating a first communication device and a commerce site after a preparation and an approval of a commercial transaction by a second communication device and the commerce site. The program includes the following means. A means for retrieving an identification record corresponding to a user of the first communication device and the second communication device. A means for establishing a communication link between the first communication device and the commerce site in response to the identification record. And, a means for providing a signature request to the first communication device upon an establishment of the communication link.

A sixth form of the present invention is a method a computer program product in a computer usable medium for completing a commercial transaction prepared and approved by a first communication device and a commerce site. The program includes the following means. A means for examining a signature request from the commerce site. A means for identifying a user of the first communication device. And, a means for providing a signature for the commercial transaction in response to an identification of the user.

Further forms, objects, features and advantages of the present invention will become apparent to the ones skilled in the art upon examination of the following description in reference to the accompanying drawings. It is intended that any additional advantages are incorporated herein.

### BRIEF DESCRIPTION OF THE DRAWINGS

FIG. 1 illustrates one embodiment of a computer device and one embodiment of a wireless portable device in accordance with the present invention;

FIG. 2 is a data flow chart of one embodiment of a commercial transaction in accordance with the present invention;

FIG. 3 is an exemplary correlation table of identification records in accordance with the present invention; and

FIG. 4 illustrates one embodiment of a secured system in accordance with the present invention.

### DETAILED DESCRIPTION OF PREFERRED EMBODIMENT

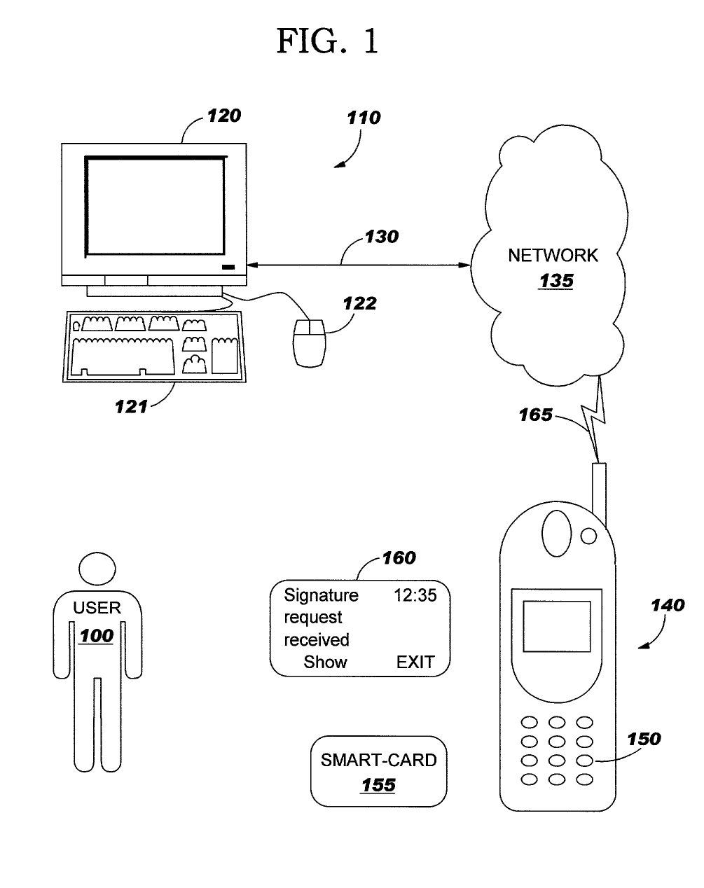

Referring to FIG. 1, a computing device in the form of a personal computer 110 (hereinafter “PC 110”) and a wireless portable device in the form of a mobile telephone 140 are shown. PC 110 provides a user 100 with access to a commercial Internet Web site to perform a transaction, e.g., the AMAZON.COM virtual bookstore at http://www.amazon.com to perform a transaction such as buying a book. This can be done by having a communication link 130 from PC 110 to a network 135 such as the Internet and running a browser on PC 110 that is capable of conveniently displaying pages from the Web site whereby user 100 can gather all necessary information on what user 100 is buying. PC 110 is equipped with a display monitor 120 preferably having at least a 5-inch wide screen (diagonal) capable of displaying 800×600 pixels or more. PC 110 is also equipped with an input device in the form of a keyboard 121 preferably having at least 100 keys and a pointing device in the form of a mouse 122.

User 100 can also establish a communication link 165 from mobile telephone 140 to network 116. Mobile telephone 140 is personalized to user 100 with a token in the form of a smart card 155 whereby user 100 may be uniquely identified. As compared to PC 110, mobile telephone 140 includes a display 160 that is limited to a few lines of a few characters, and a rudimentary numeric keyboard 150.

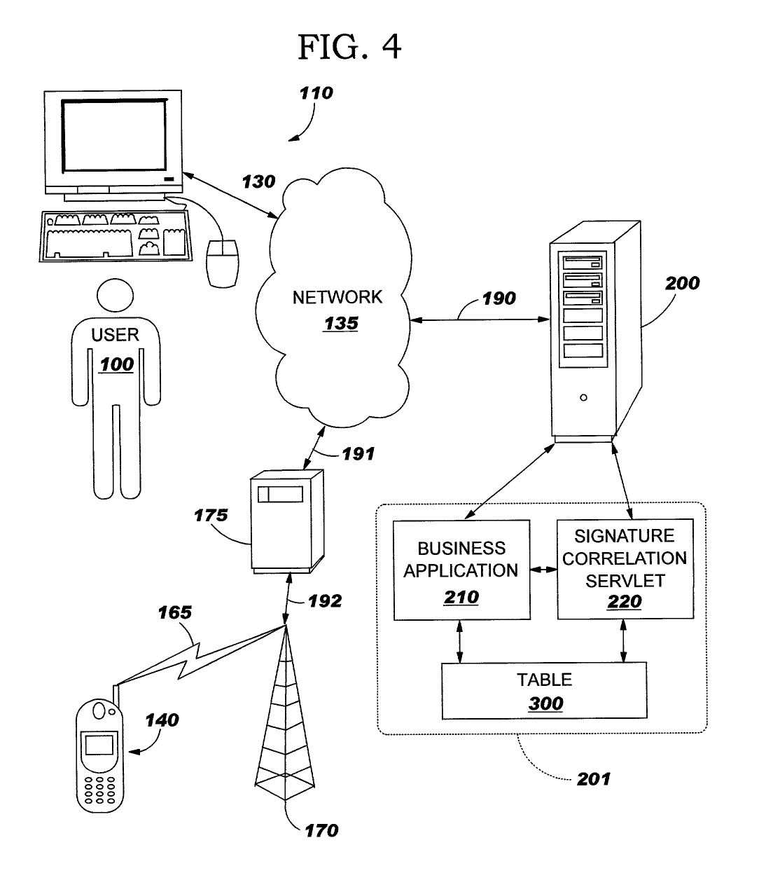

Referring additionally to FIG. 4, a secured system 101 in accordance with the present invention in shown. System 101 comprises PC 110, mobile phone 140, network 135, and a server 200. Server 200 includes a software and data package 201 having a business application 210, a signature correlation servlet 220, and a table 300 consisting of identification records of people/businesses having authorization to access business application 210. A commercial transaction in accordance with the present invention initially involves user 100 running PC 110 to access business application 210 on server 200 over network 135 via communication link 130 and a communication link 190. Business application 210 is a core of a commercial-like site that user 100 wants to deal with. User 100 approves the commercial transaction when user 100 is satisfied with the contents and the objects of the transaction. Upon receipt of the approval, business application 210 uses table 300 to identify an identification record of user 100. Upon identifying an identification record of user 100, servlet 220 contacts mobile phone 140 through network 135, a gateway 175, and a tower 170 via communication link 190, a communication link 191, a communication link 192, and communication link 165. Servlet 220 then sends a signature request to mobile phone 140 according to the Wireless Application Protocol (WAP). User 100 uses a private key of smart card 155 to sign for the commercial transaction. Business application 210 and servlet 220 complete the transaction upon receipt of the signature of user 100. Those having ordinary skill in the art will appreciate that the commercial transaction meets all the goals of confidentiality, authentication, integrity and non-repudiation.

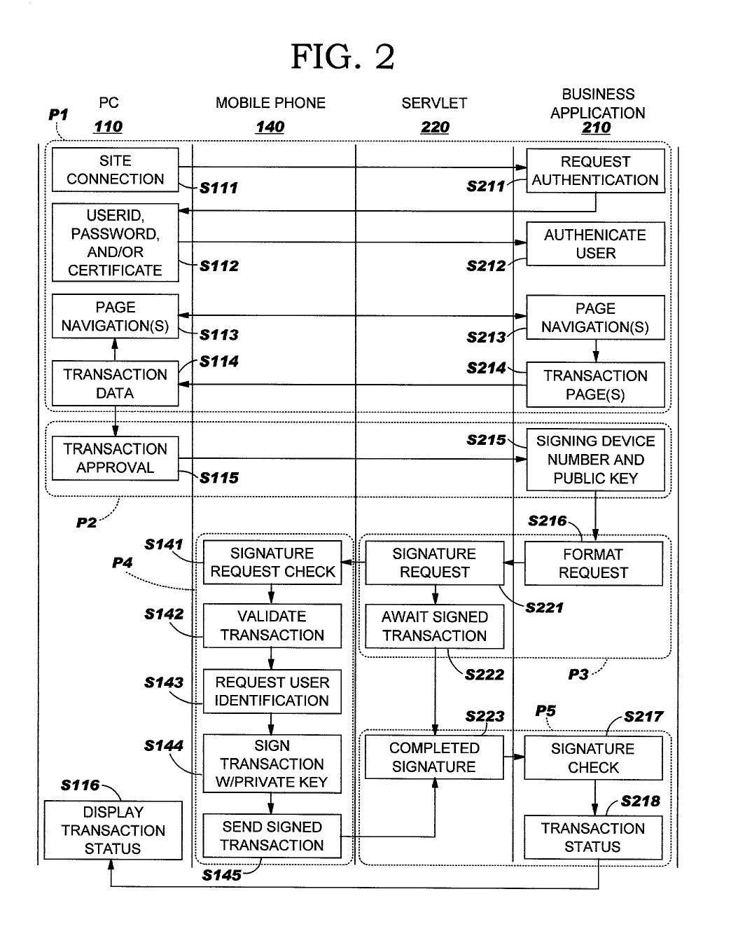

Referring to FIGS. 2 and 4, a more detailed embodiment of a commercial transaction in accordance with the present invention as implemented by user 100 involving system 101 will now be described herein. A complete execution of the commercial transaction consists of a preparation phase P1, an approval phase P2, a signature request phase P3, a signature phase P4, and a transaction completion phase P5. In one embodiment, PC 110 and mobile phone 140 both include a computer program product within a computer readable medium for performing the applicable acts that are described in FIG. 2. From the following description of FIG. 2, those having ordinary skill in the art will appreciate that the commercial transaction can be implemented by user 100 involving alternative embodiments of system 101 that comprise a computing device other than PC 110 and/or a wireless portable device other than mobile phone 140. Those having ordinary skill in the art will also appreciate that the commercial transaction can be implemented by user 100 involving alternative embodiments of system 101 that comprise a communication device other than a computing device and/or a wireless portable device.

The commercial transaction is initiated from PC 110 during a stage S111 when user 100 utilizes PC 100 to access business application 210 on server 200 over network 116. Server 200 runs business application 210 for setting up a commerce site for user 100. For example, business application 210 can be for setting up the AMAZON.COM virtual bookstore. During a stage S211, business application 210 request client authentication from user 100. During a stage S112, user 100 responds to the authentication request by complying with whatever method is in effect in server 200. For example, user 100 can provide credentials to be recognized as a legitimate user. In one embodiment, user 100 sends a user ID with a password to server 200. Other embodiments may require user 100 and/or server 200 to send certificates issued by a third party trusted by user 100 and owners of server 200, e.g., a CA (Certificate Authority).

During a stage S212, server 200 authenticates user 100 unless user 100 fails to timely and satisfactorily response to the authentication request of stage S211 in which case the transaction is aborted by server 200. All of this can actually be implemented from various well-known methods known by those skilled in the art. Many variants exist. In one embodiment, certificates could be X.509 certificates as described in RFC2459 of the Request For Comments of the Internet Engineering Task Force used by the Web browsers supporting Secure Socket Layer protocol which is being standardized under the name of Transport Layer Security protocol in RFC2246. As far as server 200 is concerned, the only other assumption is that it is capable of generating static and dynamic Hyper Text Markup Language pages that can be viewed from PC 110 by user 100.

When user 100 has been recognized as a legitimate user by server 200, user 100 is then permitted during a stage S113 to browse the HTML pages of business application 210 so as to gather all the necessary information regarding the commercial transaction user 100 wants to perform. This assumes that multiple exchanges may have to take place between PC 100 and server 200 during stage S113 and a stage S213, and generally requires that user 100 fill virtual forms during a stage S114 such as dynamic HTML pages formatted by server 200 during a stage S214. Server 200 interprets the content of the virtual forms so as to determine what user 100 intends to do. For example, when the business application 210 is for AMAZON.COM, a virtual shopping cart is filled with that which user 100 desires to acquire. While filling the virtual shopping cart, user 100 has the option of returning to stage S113 to review and consult all of the information and data provided by server 200 during stage S213 that relates to the commercial transaction before proceeding to a virtual cash register.

Upon being satisfied with the contents of the transaction, user 100 uses PC 110 to approve the commercial transaction during a stage S115. For example, user 100 can proceed to stage S115 when user 100 has finished filling the virtual shopping cart at AMAZON.COM. Also by example, user 100 can proceed to stage S115 when user 100 has finalized a list of shares he wants to sell or buy through a preferred broker. Obviously, although not explicitly shown, user 100 always has the freedom of aborting the commercial transaction any time before completion. Also, the commercial transaction may be aborted due to any malfunction of PC 110, network 135, and/or server 200 such as an interruption of communication link 115 and/or communication link 190. However, normally, the transaction is approved by user 100 from PC 110.

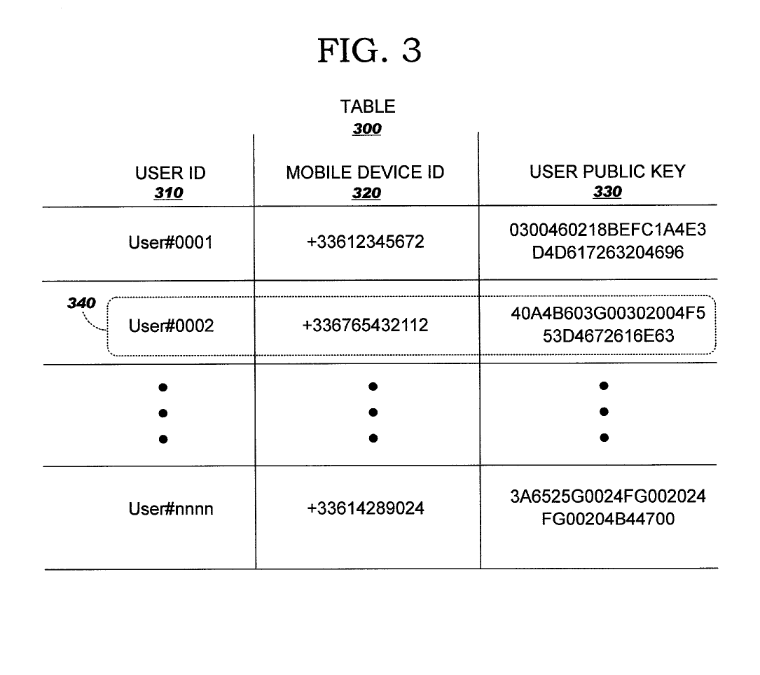

During a stage S216, server 200 desires to obtain a signature of user 100. In one embodiment, server 200 manages table 300 for cross-referencing an user identification (ID) of user 100 along with a corresponding mobile device ID of mobile phone 140 and a public key that is encrypted on smart card 155. An example of table 300 is shown in FIG. 3. Referring to FIG. 3, table 300 lists users IDs in a column 310 that are recognized by server 200 as being legitimate users authorized to deal with business application 220. For each registered user, table 300 lists a corresponding mobile device ID number in column 320 and a corresponding user public key in column 330. Each row of user ID, mobile device ID, and user public key constitutes an identification record of the corresponding user such as identification record 340. The precise form under which table 300 is actually implemented and the way it is searched when interrogated is beyond the scope of the invention. Those having ordinary skilled in the art will recognize that numerous alternate ways are feasible, e.g., tailored to favor performance or memory size required. As an example, table 300 could be implemented to obey the specifications of a Lightweight Directory Access Protocol (LDAP). LDAP is a protocol for accessing on-line directory services defined by the Internet Engineering Task Force in Request For Comments (RFC), especially RFC 777. LDAP defines a relatively simple protocol for updating and searching directories running over the Internet suite of protocols (TCP/IP). An LDAP directory entry is a collection of attributes with a name, called a distinguished name (DN). The DN refers to the entry unambiguously. Each of the entry's attributes has a type and one or more values.

The types are typically mnemonic strings, like “cn” for common name, or “mail” for e-mail address. LDAP directory entries are arranged in a hierarchical structure that reflects political, geographic, and/or organizational boundaries. Entries representing countries appear at the top of the tree. Below them are entries representing states or national organizations. Below them might be entries representing people, organizational units, printers, documents, or just about anything else. Therefore, cross-referencing table 300 of the invention can advantageously be implemented under the form of a customized LDAP directory.

Referring again to FIGS. 2 and 4, during stage S215, server 200 retrieves a phone number for mobile phone 140 and a user public key for smart card 155 from table 300 that corresponds to user 100. During a stage S216, business application 210 formats the transaction data to provide a signature request to PC 110. Business application 210 optionally signs the signature request using the user smart-card public key and optionally countersigns the signature request with a server private key whereby user 100 needs to be certain of the origin of the transaction. During a stage S221, servlet 220 dials mobile phone 140 using standards for allowing server 200 to deliver data to a mobile phone 140 even though mobile phone 140 has not issued any request for the data. During a stage S222, servlet 220 awaits a response from mobile device 140. In one embodiment, signing servlet 220 is a Java™ Servlet. While Java™ is, among other things, a popular, simple, object-oriented, distributed and interpreted general-purpose programming language developed by Sun Microsystems (Sun Microsystems, Inc., 90 San Antonio Road, Palo Alto, Calif. 940 USA.), a Java™ Servlet is a small, platform-independent Java™ program that can be used to extend the functionality of server 200 in a variety of ways. Thus, a Java™ Servlet is convenient to implement the signing function of the invention. Those having ordinary skill in the art of the invention will recognize that, without departing from the spirit of the invention, it may be implemented in many alternate equivalent ways. In one embodiment, signature request phase P3 is completely imbedded within business application 210.

Upon an acceptance by user 100 of an incoming call from server 200, during a stage S141, smart-card 155 checks the generated transaction content that is optionally signed with a user public key and optionally countersigned with a server private key to ascertain its origin if necessary. During a stage S142, user 100 is prompted to validate the transaction. At this point user 100 may want to review the content of the transaction received on mobile phone 140 (which is sufficient in general to be sure what transaction is being signed). In one embodiment, the transaction may be displayed on mobile screen 160, preferably in an abridged form for the sake of convenience due to the limited capacity of the display of such devices. In another embodiment, a number associated with the transaction may be displayed on mobile screen 160. This is a common practice when dealing with a server such as server 200 or ordering goods or services over the phone. This transaction number may thus be used as a correlator so user 100 is made certain of what transaction is being validated.

During a stage S143, smart-card 155 requests a form of identification of user 100. In one embodiment, smart-card 155 requests a personal identification number (PIN) from user 100. In another embodiment, smart-card 155 requests biometric data in the form of finger prints or other identifying marks of user 100 that are recognized through an appropriate sensor placed on smart-card 155. This will add definitively to the security hence, better contributing to reach the goals of authentication, integrity and non-repudiation. Smart-card 155 signs the transaction using a user private key during a stage S144 upon receipt of the identification, and sends the signed transaction to server 200 during a stage S145. At this point, the signature phase P4 to carry out signature of the secure transaction in mobile device 140 is over.

During a stage S223, servlet 220 receives the signed transaction to complete a signature cycle of the transaction. During a stage S217, business application 210 performs a checking step in server 200 utilizing user public key. If the result of the checking step is positive, business application 210 formats a transaction status indicating an approval of the transaction during a stage S218. User 100 views the transaction status during a stage S116.

While the embodiments of the present invention disclosed herein are presently considered to be preferred, various changes and modification can be made without departing from the spirit and scope of the present invention. The scope fo the present invention is indicated in the appended claims, and all changes that come within the meaning and range of equivalents are intended to be embraced therein.

What is claimed is:

1. A method for associating a commerce site, a first communication device, and a second communication device in executing a commercial transaction over a network, said method comprising:
operating the first communication device and the commerce site to prepare and approve the commercial transaction;
operating the commerce site to provide a signature request to the second communication device upon an approval of the commercial transaction; and
operating the second communication device to provide a signature to the commerce site in response to said signature request.

2. The method of claim 1, further comprising:
operating the commerce site to complete the commercial transaction in response to said signature.

3. A method for associating a first communication device and a commerce site after a preparation and an approval of a commercial transaction by a second communication device and the commerce site, said method comprising:
operating the commerce site to retrieve an identification record corresponding to a user of the first communication device and the second communication device;
operating the commerce site to establish a communication link between the first communication device and the commerce site in response to said identification record; and
operating the commerce site to provide a signature request to the first communication device upon an establishment of the communication link.

4. The method of claim 3, further comprising:
operating the first communication device to examine said signature request upon receipt of said signature request.

5. The method of claim 3, further comprising:
operating the second communication device to identify said user in response to said signature request.

6. The method of claim 3, further comprising:
operating the second communication device to provide a signature for the commercial transaction to the commerce site in response to said signature request.

7. A method for completing a commercial transaction prepared and approved by a first communication device and a commerce site, said method comprising:
operating the commerce site to provide a signature request to a second communication device;
operating said second communication device to examine said signature request;
operating said second communication device to identify a user of the first communication device and the second communication device; and
operating said second communication device provide a signature for the commercial transaction in response to an identification of said user.

8. The method of claim 7, further comprising:
operating the commerce site to complete the commercial transaction upon a receipt of said signature from said second communication device.

9. A system for completing a commercial transaction, said system comprising:
a first communication device;
a second communication device; and
a server running a commerce site,
wherein said first communication device and said server are operable to prepare and approve the commercial transaction,
wherein said server is further operable to provide a signature request to said second communication device upon an approval of the commercial transaction, and
wherein said second communication device is operable to provide a signature to said server in response to said signature request.

10. The system of claim 9, wherein
said first communication device is a computing device.

11. The system of claim 9, wherein
said second communication device is a wireless portable device.

12. The system of claim 9, wherein
said server is further operable to provide an authentication request of a user of said first communication device; and
said first communication device is further operable to provide an authentication data to said server in response to said authentication request.

13. The system of claim 9, wherein
said server is further operable to retrieve an identification record corresponding to a user of said first communication device and said second communication device; and
said server is further operable to establish a communication link between said server and said second communication device in response to said identification record.

14. The system of claim 9, wherein
said server is further operable to provide said signature request including a user public key corresponding to a user of said first communication device and said second communication device.

15. The system of claim 9, wherein
said server is further operable to provide said signature request including a private key corresponding to said server.

16. The system of claim 9, wherein
said second communication device is further operable to examine said signature request.

17. The system of claim 9, wherein
said second communication device is further operable to identify a user of said first communication device and said second communication device in response to said signature request.

18. The system of claim 9, wherein
said second communication device is further operable to provide said signature including a user private key.

19. The system of claim 9, wherein
said server is further operable to examine said signature.

20. The system of claim 18, wherein
said server is further operable to examine said user private key.

21. A computer program product in a computer usable medium for associating a first communication device and a commerce site after a preparation and an approval of a commercial transaction by a second communication device and the commerce site, said program comprising:
a means for retrieving an identification record corresponding to a user of the first communication device and the second communication device;
a means for establishing a communication link between the first communication device and the commerce site in response to the identification record; and
a means for providing a signature request to the first communication device upon an establishment of the communication link.

22. A computer program product in a computer usable medium for completing a commercial transaction prepared and approved by a first communication device and a commerce site, said program comprising:
a means for examining a signature request from the commerce site;
a means for identifying a user of the first communication device; and
a means for providing a signature for the commercial transaction in response to an identification of the user.
